(19) United States
(12) Patent Application Publication
(10) Pub. No.: US 2017/0217285 A1
(43) Pub. Date: Aug. 3, 2017

(54) Method for Controlling or Regulating a Coolant Circuit of a Motor Vehicle Air Conditioning System

(71) Applicant: Bayerische Motoren Werke Aktiengesellschaft, Muenchen (DE)

(72) Inventors: Robert HERBOLZHEIMER, Groebenzell (DE); Oliver HORN, Muenchen (DE); Stefan MORGENSTERN, Muenchen (DE)

(21) Appl. No.: 15/484,188

(22) Filed: Apr. 11, 2017

Related U.S. Application Data
(63) Continuation of application No. PCT/EP2015/073966, filed on Oct. 16, 2015.

(30) Foreign Application Priority Data
Oct. 17, 2014 (DE) 10 2014 221 106.9

(51) Int. Cl. B60H 1/00; B60H 1/32

(52) U.S. Cl. CPC B60H 1/00885; B60H 1/3205; B60H 2001/3236; B60H 2001/3285

(57) ABSTRACT

A method and a correspondingly designed device are provided for controlling or regulating a coolant circuit of an air conditioning system, which includes at least one compressor, at least one condenser or gas cooler, and at least one evaporator. A controllable coolant expansion device is connected to the coolant inlet of the evaporator. It is detected when the coolant circuit is under filled with a coolant and, when an under filling of the coolant is detected, the control strategy of the expansion device is changed.

### CROSS REFERENCE TO RELATED APPLICATIONS

This application is a continuation of PCT International Application No. PCT/EP2015/073966, filed Oct. 16, 2015, which claims priority under 35 U.S.C. §119 from German Patent Application No. 10 2014 221 106.9, filed Oct. 17, 2014, the entire disclosures of which are herein expressly incorporated by reference.

### BACKGROUND AND SUMMARY OF THE INVENTION

The invention relates to a method and to a correspondingly designed device for controlling or regulating a coolant circuit of a motor vehicle air conditioning system.

Motor vehicle air conditioning systems have a coolant circuit through which flows the coolant which is necessary for cooling the air. Coolant may escape out of the coolant circuit over the operational life of the system due to system-induced leakages or due to damage. In a coolant circuit which is filled with too little coolant, unusually high overheating occurs in the evaporator under cooling power demands. In order to realize the required cooling power, it is possible, for example, depending on the control and regulating concept, for the compressor to be driven ever more powerfully. Depending on the principle of control of the compressor in the coolant circuit, the suction pressure upstream of the compressor is therefore increasingly reduced, in which case it is attempted to provide sufficient cooling power despite the overheating of the coolant. In other coolant circuit regulating concepts, among other regulating concepts which have stored suction pressure regulation, when the coolant circuit is underfilled then the rotational speed or the displaced volume of the compressor may automatically be reduced since, when there is underfilling, the suction pressure required for air conditioning is reached very rapidly.

The suction pressure which is very low in the first case may lead to severe damage to the coolant compressor or compressor. Due to the lack of coolant, malfunctions of the oil circulation in the coolant circuit may also occur and these may also lead to damage to the coolant compressor. In the second case, the cooling system no longer has sufficient power to carry out the cooling task.

Especially when R744 is used as the coolant, the storage of a sufficient quantity of coolant to compensate for filling quantity losses due to leakages over an appropriate maintenance interval is possible only at high costs and taking up of a large amount of construction space since, especially with “R744 coolant”, the maximum permitted filling density of the system constitutes a limiting factor.

In order to especially protect those air conditioning systems which are operated without suction pressure regulation (as are more customary when R744 is used) from damage due to the filling level of coolant being too low, the coolant filling quantity of the air conditioning systems is continuously monitored. If an erroneous filling quantity is determined, the control of the coolant compressor is changed or the latter is no longer switched on and/or a warning is generated. A corresponding method for “underfilling protection” is disclosed, for example, in DE 10 2008 050 163 A1.

It is an object of the invention to provide a method for avoiding damage to the coolant circuit due to underfilling of the coolant by appropriate control and/or regulation of the motor vehicle air conditioning system, in particular of the coolant circuit, and, by way of a suitable method, to extend the reliable operation of the coolant circuit down to lower degrees of filling and therefore to extend the maintenance interval for the filling of the coolant circuit.

This and other objects are achieved by a method and a device for controlling or regulating a coolant circuit of a motor vehicle air conditioning system in accordance with embodiments of the invention.

The invention is based on a motor vehicle air conditioning system with a coolant circuit, wherein the coolant circuit comprises at least one compressor, a condenser or gas cooler, an externally regulable coolant expansion device and an evaporator. The coolant compressed by the compressor is supplied to the condenser or gas cooler which, in turn, is connected via an internal heat exchanger and a coolant expansion device to the evaporator. A collector in which the coolant is collected can also be arranged downstream of the evaporator or downstream of the condenser or gas cooler.

The invention is now based on the finding that an underfilling of the coolant leads to a power deficit of the air conditioning system. This leads, in turn, to overheating of the coolant downstream of the evaporator as soon as the quantity of coolant stored in the collecting container is used up and otherwise not compensated for by, for example, a greater opening of the expansion member at this operating point.

Taking into consideration the above finding, a first aspect of the invention is focused on a method wherein, first of all, an underfilling of the coolant in the coolant circuit can be detected. If an underfilling of the coolant, in particular an undesirable underfilling of the coolant, is detected, the control strategy of the controllable expansion device is changed in respect of compensating for the power deficit caused because of the underfilling of the coolant.

If an (undesirable) underfilling of the coolant is now determined, a change is advantageously made from the standard control strategy of the externally adjustable expansion device, the standard control strategy regulating the degree of opening of the expansion device or the quantity of flow through the expansion device in order to set the coolant pressure, to an optimum coolant high pressure. In particular, the control strategy of the expansion device is changed in favor of lowering the high pressure downstream of the compressor or increasing the flow of coolant through the expansion device, and therefore the power deficit arising because of the underfilling of the coolant can be compensated for. Expressed in other words, when an undesirable underfilling of the coolant is detected, the control strategy of the (externally) controllable expansion device is changed in such a manner that the latter is adjusted to an underfilling-dependent desired high pressure of the coolant that is advantageously lower than the predetermined optimum high pressure of the coolant at an optimum coolant filling quantity, i.e. when the coolant circuit is not undesirably underfilled. Coolant is displaced here from the high pressure side to the low pressure side, as a result of which the negative effects of the underfilling are compensated for to a certain degree. At the latest whenever a corresponding compensation of the power deficit is no longer (completely) possible, a corresponding warning can also be emitted to the driver and/or the coolant circuit can be deactivated and/or a fault memory entry undertaken.

As has already been explained above, a corresponding changed control strategy of the controllable expansion device is undertaken whenever an “undesirable underfilling of the coolant” is detected. An undesirable underfilling of the coolant is detected, for example, whenever initial effects of the underfilling of the coolant on the air conditioning comfort or the power are detected, or whenever critical states are detected in certain components of the motor vehicle air conditioning system, i.e. an undesirable underfilling is detected with reference to the negative effects which arise when the control strategy remains the same. For example, an undesirable underfilling of the coolant circuit is detected on the basis of an arising inhomogeneity of the temperature of the outflowing air between evaporator inlet and evaporator outlet. An underfilling can be considered undesirable in particular whenever the symptoms which arise and can be evaluated on the basis of the underfilling of the coolant deviate by more than a predetermined extent from the desired or normal value.

For the determination of an (undesirable) underfilling of the coolant downstream of the evaporator, various parameters can therefore be detected and correspondingly evaluated. In principle, it is appropriate here to detect an underfilling of the coolant or an overheating of the coolant downstream of the evaporator by evaluation of the temperature of the coolant at the evaporator outlet and evaporator inlet, wherein the differential temperature is a measure of the overheating. Furthermore, it is possible to detect underfilling at the evaporator with reference to the air-side temperature differences on the air-outlet side.

In a further advantageous configuration, an underfilling of the coolant, in particular an undesirable underfilling of the coolant, can be detected by way of a filling level measurement of the coolant in the collector, i.e. by evaluating the signals of a sensor which can detect the filling level of the coolant.

The method according to the invention and the advantageous refinements thereof can be carried out via an implemented algorithm or a corresponding assembly arrangement in a control device provided for this purpose, in particular in an air conditioning system control unit.

A second aspect of the invention is focused on a device for controlling or regulating a coolant circuit of a motor vehicle air conditioning system, which comprises at least one compressor, the outlet of which is connected to a condenser or gas cooler, and an evaporator, the inlet of which is connected to a controllable coolant expansion device (EXV). Measures are provided here for detecting an underfilling of the coolant in the coolant circuit and further measures are provided which, when an underfilling of the coolant is detected, change the control strategy of the expansion device. Coolant lines are provided as connecting elements between the individual components.

The statements above regarding the method according to the invention according to the first aspect of the invention also apply in a corresponding manner to the device according to the invention according to the second aspect of the invention.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic, simplified construction of a coolant circuit of a motor vehicle air conditioning system (not illustrated specifically).

FIG. 2 is a simplified diagram for illustrating a possibility of refining the exemplary method according to the invention.

### DETAILED DESCRIPTION OF THE DRAWINGS

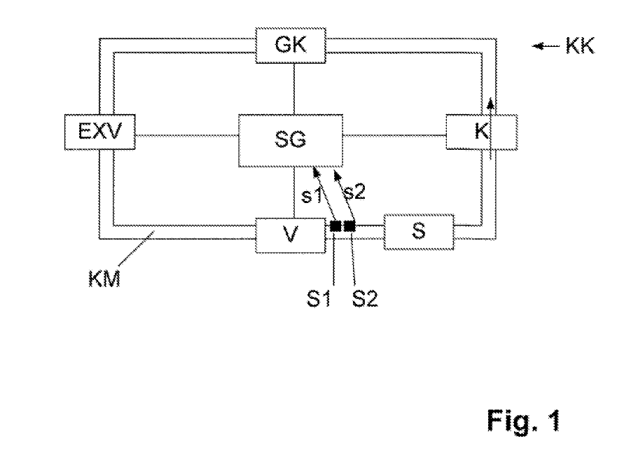

The coolant circuit KK, illustrated in FIG. 1, of a motor vehicle air conditioning system includes a compressor K for compressing the coolant KM, downstream of which on the high pressure side is a condenser or gas cooler GK. An externally adjustable or controllable coolant expansion device EXV, which is followed by an evaporator V, is connected downstream of said condenser or gas cooler GK. A collector S can also be provided downstream of the evaporator V or downstream of the condenser/gas cooler GK. As a rule, “R744 coolant circuits” generally also contain an internal heat exchanger, which is omitted on the illustration here. For the precise configuration of such coolant circuits, reference is made to the known prior art.

An air conditioning control unit SG controls the operation of the air conditioning system in a conventional manner depending on the activation signal directly or indirectly (by control or regulation of the evaporator temperature) to the coolant flow or coolant differential pressure realized between the high pressure part and low pressure part of the coolant circuit KK. Furthermore, a first and second sensor S1 and S2 are provided, wherein the first sensor S1 here detects the temperature s1 of the coolant KM downstream of the evaporator V, and the second sensor S2 detects the pressure s2 of the coolant KM downstream of the evaporator V. The two signals s1 and s2 are transmitted to the air conditioning system control unit SG. Alternatively, the air-side temperature difference downstream of the evaporator is also determined, and this is used as a measure of the underfilling. Similarly, the coolant-side temperature difference can also be determined and used as a measure of the underfilling.

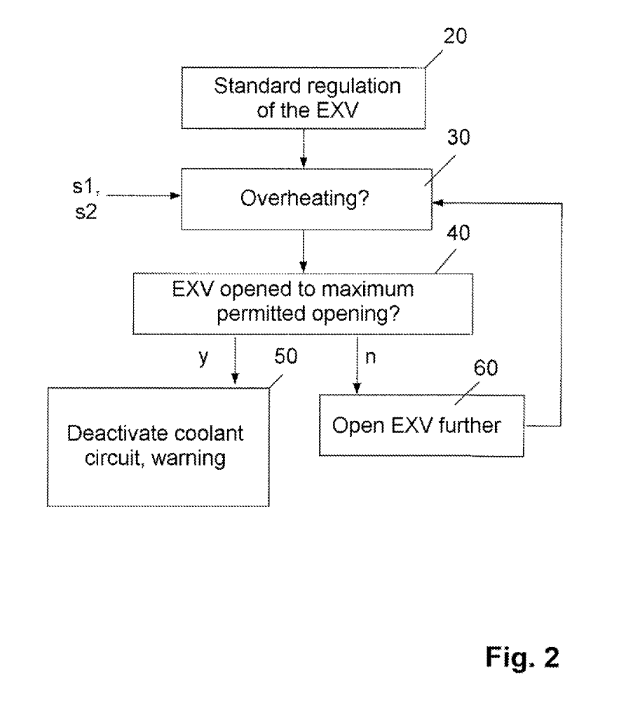

FIG. 2 now shows an advantageous configuration of the method according to the invention with reference to a simplified flow diagram. The diagram starts at step 20, wherein here first of all a standard regulation of the coolant circuit is undertaken or is maintained. The externally controllable expansion device EXV is set or adjusted here in accordance with a predefined control strategy, for example for setting an optimum high pressure.

In the next step 30, the two supplied signals s1 and s2 are evaluated in order to detect overheating. If overheating of the coolant downstream of the evaporator is determined, first of all, in the next step 40, the degree of opening of the expansion device EXV is checked. If the expansion device EXV is not yet completely open, the expansion device EXV is activated in step 60 in such a manner that the coolant flow is increased. If, however, it is determined in step 40 that the expansion device is already open to a maximally permitted opening, a transition is made to step 50 and, in order to avoid damage, the coolant circuit is deactivated and a warning output to the driver. Further opening of the expansion device can also be achieved by the control variable, i.e., for example, the desired pressure of the coolant being changed in such a manner that, by controlling or regulating the expansion device, the flow of coolant is increased.

Alternatively to the embodiment illustrated here, the checking for overheating can also be undertaken immediately at the beginning of the method and, depending on the result, either the standard regulation can be started or the expansion device can be opened further. A parallel procedure (standard regulation and parallel checking for overheating of the coolant) would likewise be possible. Depending on the overheating value or extent, a different target value for the optimum high pressure regulation can then be determined, and therefore there can be a response to the underfilling within the standard regulation. If the overheating is excessive and the expansion member has already been opened to the defined maximally permitted opening, then the overheating cannot be compensated for further.

By means of this method, when an underfilling of the coolant is detected, the operation of the coolant circuit can be further maintained at least initially. This results in an extension of the operating period of the coolant circuit despite the reduced quantity of coolant. Customer satisfaction can therefore also be increased since, because of the error detection and initiating of appropriate countermeasures, first of all the period before the required maintenance is extended, and also prompt maintenance and topping up of the coolant can then be carried out.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for controlling or regulating a coolant circuit of a motor vehicle air conditioning system having a compressor, a condenser or gas cooler, and an evaporator, as well as a controllable coolant expansion device connected to a coolant inlet of the evaporator, the method comprising the acts of:
detecting an underfilling of coolant in the coolant circuit; and
when an undesirable underfilling of the coolant is detected in the coolant circuit, changing a control strategy of the controllable coolant expansion device.

2. The method according to claim 1, wherein
when the undesirable underfilling of the coolant is detected, the changing of the control strategy is carried out by deviating from a standard control strategy of the controllable coolant expansion device in order to set an optimum high pressure of the coolant.

3. The method according to claim 1, wherein
when the undesirable underfilling of the coolant is detected, the changing of the control strategy is carried out such that the expansion device is adjusted to an underfilling dependent desired high pressure of the coolant that is lower than a predetermined optimum high pressure when the coolant circuit is not underfilled.

4. The method according to claim 1, wherein
the undesirable underfilling of the coolant is detected when: (i) initial effects of the underfilling of the coolant on air conditioning comfort or power are detected, or (ii) critical states of air conditioning system components are detected.

5. The method according to claim 1, wherein
when an underfilling of the coolant is detected, the control strategy of the controllable coolant expansion device is changed in favor of an increase in flow of the coolant through the expansion device.

6. The method according to claim 1, wherein
the underfilling of the coolant in the coolant circuit is detected by detecting overheating of the coolant downstream of the evaporator.

7. The method according to claim 1, wherein
the underfilling of the coolant in the coolant circuit is detected via a filling level measurement of the coolant in a collector of the air conditioning system.

8. A device for controlling or regulating a coolant circuit of a motor vehicle air conditioning system equipped with a compressor, a condenser or gas cooler, and an evaporator as well as a controllable coolant expansion device connected to an input of the evaporator, the device comprising:
an air conditioning control unit including a processor executing instructions to:
detect an underfilling of the coolant in the coolant circuit; and
when an undesirable underfilling of the coolant is detected, change a control strategy of the controllable coolant expansion device.
